(19) United States
(12) Patent Application Publication
(10) Pub. No.: US 2023/0078405 A1
(43) Pub. Date: Mar. 16, 2023

(54) APPARATUS AND METHODS FOR PALLET LOAD MONITORING

(71) Applicant: QUANTRONIX, INC., Farmington, UT (US)

(72) Inventors: Brandon M. Taylor, Kaysville, UT (US); Heath A. Pritchett, Kaysville, UT (US); Justin G. Norman, West Point, UT (US); Dean G. Simmons, Fruit Heights, UT (US)

(21) Appl. No.: 17/930,482

(22) Filed: Sep. 8, 2022

Related U.S. Application Data
(60) Provisional application No. 63/261,155, filed on Sep. 14, 2021.

(51) Int. Cl. B65D 19/38; B65D 19/00

(52) U.S. Cl. CPC B65D 19/38; B65D 19/0002; B65D 2519/00004

(57) ABSTRACT

Apparatus, systems and methods for monitoring loads on a pallet, each apparatus using one or more force sensors placed under and along a single side of a loaded pallet. In embodiments, each apparatus comprises one or more low profile force sensors in one or more housings mountable on an underlying floor surface, carrying self-contained power supplies and having an associated Bluetooth transceiver. The apparatus force sensors output signals corresponding to pallet loads and load changes. Multiple apparatus may comprise a system including a base station having a Bluetooth transceiver for communicating with each the Bluetooth transceiver of each apparatus.

### CROSS-REFERENCE TO RELATED APPLICATIONS

This application claims the benefit of the priority date of U.S. Provisional Patent Application No. 63/261,155, filed Sep. 14, 2021, and titled “APPARATUS AND METHODS FOR PALLET LOAD MONITORING,” the disclosure of which is incorporated herein in its entirety by this reference.

### TECHNICAL FIELD

Embodiments of the present disclosure relate to apparatus and methods for determining a load of articles on a support structure relative to an initial load, as articles are removed over time. More particularly, embodiments of the present disclosure relate to apparatus and methods for determining a load of articles residing on a pallet relative to an initial load of such articles, in substantially real time, and reporting at least one of a magnitude of the relative load or changes in load as articles are removed from the pallet.

### BACKGROUND

A significant issue in optimizing warehouse or other facility floor space involves providing a sufficient and ongoing source of packaging materials for shipping goods. For example as cardboard box flats (i.e., unconstructed precut cardboard boxes in a flat state) of various sizes are required, to prevent delays in packaging for shipping due to absence of a given cardboard box flat size on the warehouse, shipping or other facility floor, it is conventional to provide one or more back-up pallets of each cardboard box size on the warehouse, shipping or other facility floor. While such a use of floor space is non-productive, it has been thought preferable to losing throughput in the packaging operation due to lack of packaging material.

So-called inventory monitoring and control systems exist to determine variations in pallet loads in real time and report the load in terms of a number of articles removed from, or remaining on, a pallet. Such existing systems are relatively complex and expensive, thus being commercially impractical for installation where a large variety of different size cardboard flats are required to supply a particular packaging station or group of stations.

In contrast, embodiments of the present disclosure address real-time pallet load monitoring in a simple yet robust and effective manner, allowing for rapid installation of large numbers of one or more embodiments of apparatus of the present disclosure. This capability provides for a single pallet location in the warehouse, shipping or other facility of each cardboard box flat size and, as a given pallet load is depleted, alert warehouse, shipping or other facility personnel of the need to furnish another replacement pallet bearing a load of the same cardboard box flat size from a remote site (i.e., outside the warehouse, shipping or other facility) before the resident pallet is empty.

### SUMMARY

Embodiments of the disclosure relate to an apparatus for monitoring a magnitude of a load on a pallet, the apparatus comprising at least one housing carrying at least one force sensor configured and positioned to provide output signals corresponding to magnitudes of the load relative to a number of articles resting on the pallet, the at least one housing configured for placement under a single side of the pallet, under substantially a center point of a single side of the pallet, or within the pallet under substantially a center point of the load.

Embodiments of the disclosure relate to a system for monitoring a magnitude of loads on multiple pallets, the system comprising two or more load sensors, each carrying at least one force sensor configured and positioned to provide output signals corresponding to magnitudes of the load relative to a number of articles resting on one pallet of the multiple pallets, a self-contained power supply and at least one Bluetooth transceiver operably coupled to a load sensor associated with a pallet thereon. Each of the two or more load sensors is configured for placement under a single side of a pallet or under substantially a center point of a single side of a pallet.

Embodiments of the disclosure relate to a method of monitoring pallet loads, the method comprising sensing a load on a pallet with a load sensor comprising one or more force sensors located under a single side of the pallet.

Embodiments of the disclosure relate to an apparatus for monitoring a magnitude of a load on a pallet, the apparatus comprising a longitudinally extending pressure bar carrying two or more longitudinally spaced and mutually connected force sensors, a longitudinally extending bar member on top of the pressure bar and comprising a vertically upstanding, longitudinally extending body and at least one back stop adjacent the longitudinally extending bar member positioned for locating a side of a pallet over the bar member when contacted by the pallet.

Embodiments of the disclosure relate to a storage cell for a pallet bearing a load of articles; the storage cell comprising a floor of a facility, a rectangular, visible boundary for the storage cell on the floor and a longitudinally extending pressure bar including two or more force sensors located along and proximate to a single side of the storage cell.

Embodiments of the disclosure relate to a method of monitoring depletion of articles from a pallet located in a storage cell, the method comprising moving the pallet into the storage cell until a side of the pallet contacts at least one back stop of a pressure bar including two or more force sensors long and adjacent one side of the storage cell, lowering the pallet to a floor of the storage cell and over the two or more force sensors of the pressure bar; and outputting signals from the two or more force sensors indicative of removal of articles from the pallet from a Bluetooth transceiver to a base Bluetooth transceiver.

### BRIEF DESCRIPTION OF THE DRAWINGS

FIG. 1A is a perspective view of a pallet jack depositing a pallet loaded with an initial load of cardboard box flats resting on a pressure bar load sensor of an embodiment of the disclosure in a first position;

FIG. 1B is a perspective view of a pallet loaded with an initial load of cardboard box flats resting on a pressure bar load sensor of the embodiment of FIG. 1A of the disclosure in a second, different position;

FIG. 2A is a perspective view of the pressure bar load sensor of the embodiment of FIGS. 1A and 1B;

FIG. 2B is an exploded perspective view of the pressure bar load sensor of FIG. 2A;

FIG. 2C is a high level schematic of components of the pressure bar load sensor of FIGS. 1A through 2B;

FIG. 2D is a high level schematic of a number of pressure bar load sensors of FIGS. 1A through 2C in communication with a base Bluetooth transceiver bridge to an Ethernet connection to a server of a warehouse or other facility network;

FIG. 2E is a high level schematic of the Bluetooth to Ethernet bridge with a port for communication to the server of a warehouse or other facility network;

FIG. 3 is a perspective view of a pallet loaded with an initial load of cardboard box flats resting on puck type load sensors of an embodiment of the disclosure;

FIG. 3A is an exploded perspective view of a puck type load sensor of the embodiment of FIG. 3;

FIG. 3B is a perspective view of a puck type load sensor of the embodiment of FIG. 3;

FIG. 4 is a perspective view of a pallet loaded with an initial load of cardboard box flats resting on a canister scale load sensor of an embodiment of the disclosure;

FIG. 4A is an exploded perspective view of a canister scale load sensor of the embodiment of FIG. 4;

FIG. 4B is a perspective sectional view of a canister scale load sensor of the embodiment of FIG. 4;

FIG. 5 is a perspective view of a pallet loaded with an initial load of cardboard box flats resting on a pallet support including canister scale load sensor of an embodiment of the disclosure;

FIG. 5A is a perspective view of the pallet support of FIG. 5 showing the location of the canister scale load sensor;

FIG. 5B is an enlarged sectional perspective of the canister scale load sensor as installed in a leg of the pallet support of FIG. 5;

FIG. 6 is an exploded perspective view of another embodiment of a pressure bar sensor of the disclosure configured for installation at the rear of a storage cell;

FIGS. 7A and 7B are, respectively, top and side elevations of a variant of the embodiment of FIG. 6, configured for installation at the rear of a storage cell;

FIG. 8 is a top view of a pair of example storage cells for receiving pallets loaded with articles, each having a pressure bar load sensor 600, 700 installed at the rear of the storage cell;

FIG. 9 is an exploded perspective view of a further embodiment of a pressure bar sensor of the disclosure configured for installation along a side of a storage cell;

FIGS. 10A and 10B are, respectively, top and side elevations of a variant of the embodiment of FIG. 9, configured for installation along the side of a storage cell;

FIG. 11 is a top view of a pair of example storage cells for receiving pallets loaded with articles, each having a pressure bar load sensor 900, 1000 installed along a side of the storage cell;

FIG. 12 is an exploded perspective view of a Bluetooth to Ethernet Bridge according to an embodiment of the disclosure;

FIG. 13 is a perspective view of an example application of the embodiment of FIG. 6 and the variant of FIGS. 7A and 7B for storage of multiple pallets in a multilevel rack;

FIG. 13A is an enlarged perspective view of upper two levels of the multilevel rack of FIG. 13;

FIG. 14 is perspective view of an example application of the embodiment of FIG. 9 and the variant of FIGS. 10A and 7B for storage of multiple pallets in a multilevel rack; and

FIG. 14A is an enlarged perspective view of upper two levels of the multilevel rack of FIG. 14.

### DETAILED DESCRIPTION

The illustrations presented herein are not actual views of any particular mine roof or method of installation, but are merely idealized representations which are employed to describe embodiments of the present disclosure.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles between surfaces that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale.

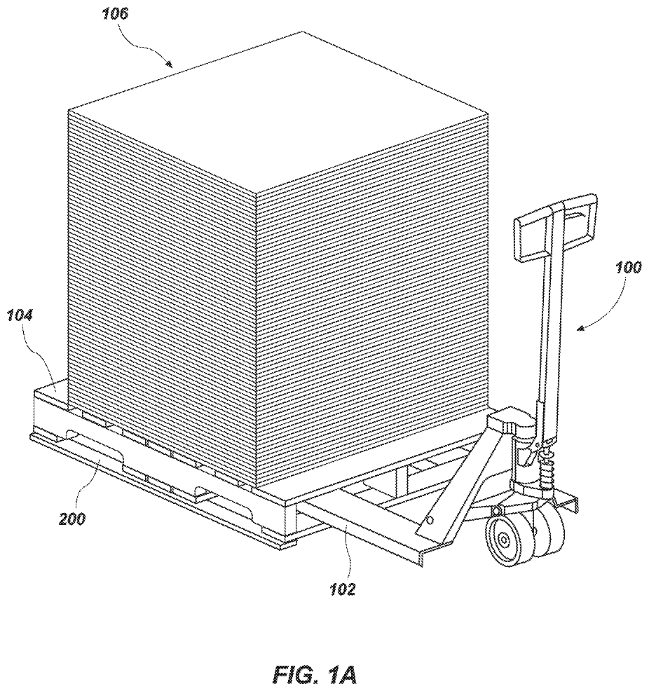

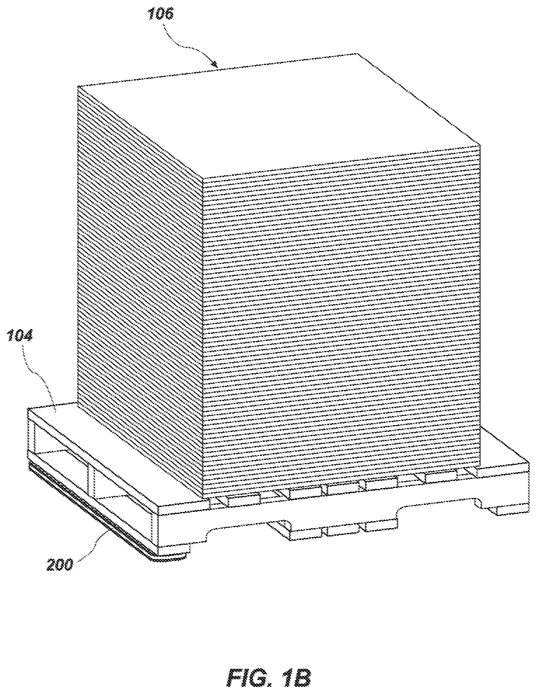

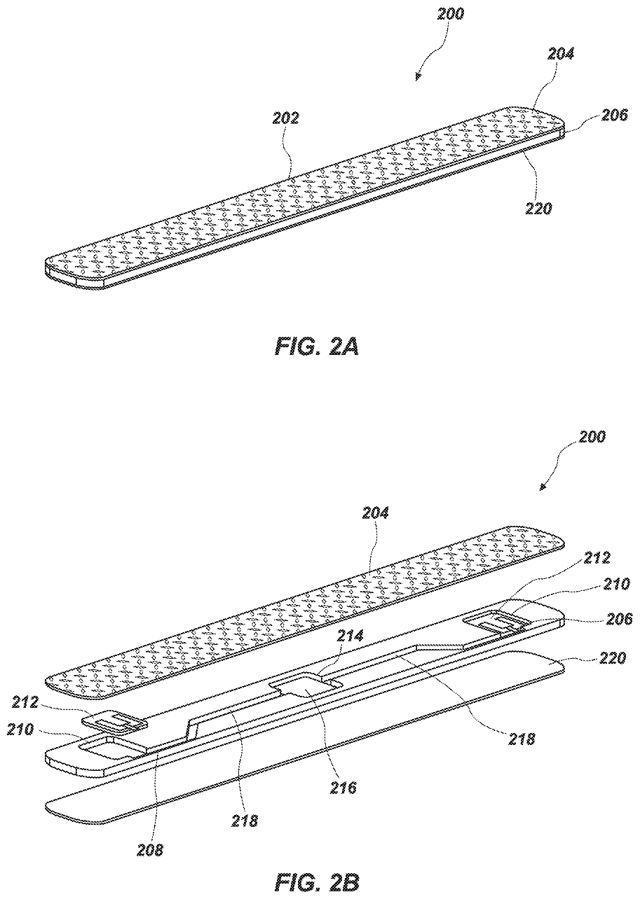

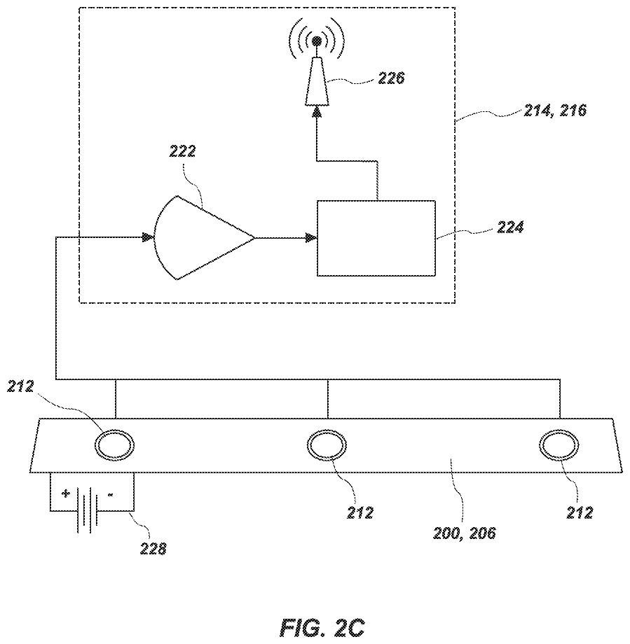

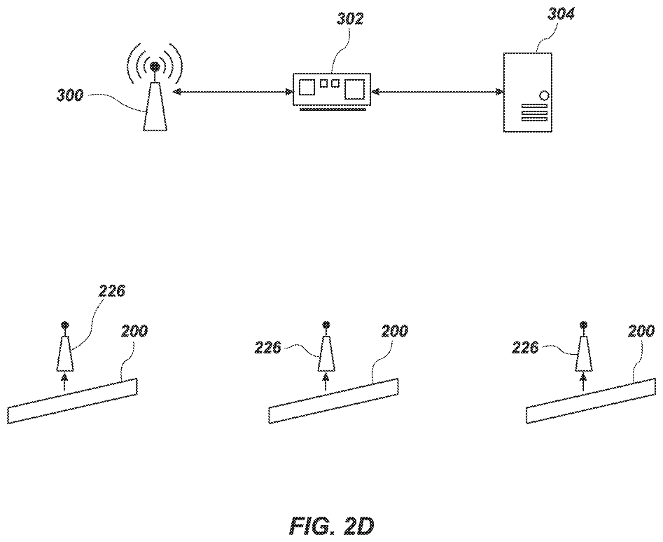

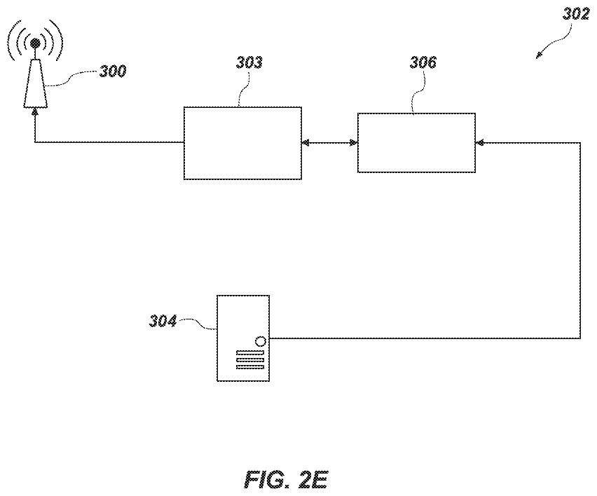

Referring to FIGS. 1A through 2E, a first embodiment of the disclosure will be described.

Referring to FIG. 1A, a pallet jack 100 is shown with fork 102 depositing a pallet 104 loaded with a number of cardboard box flats 106 onto a pressure bar load sensor 200 under and aligned with a left-hand side (as shown) of pallet 104 parallel to a direction of insertion of fork 102 under pallet 104. In practice, this initial load will generally comprise a full (i.e., maximum) pallet load.

Referring to FIG. 1B, pallet 104 loaded with a number of cardboard box flats 106 rests on a pressure bar load sensor 200 under and aligned with a side (as shown) of pallet 104 opposite the side through which a fork 102 (not shown) of a pallet jack 100 had been inserted to lift and move pallet 104.

FIGS. 2A and 2B depict pressure bar load sensor 200 comprising a pressure plate (e.g., steel) 202 with a diamond pattern or other non-skid upper topography 204 for traction and pallet stability over a sensor and electronics housing 206 (e.g., aluminum) with an upwardly facing recess 208 including cavities 210 for receiving force sensors 212 proximate each end thereof and center cavity 214 for receiving a force sensor 212 (not shown) and associated electronics 216 (further described with respect to FIG. 2C). Force sensors 212 may be piezoresistive force sensors, for example the FlexiForce™ A401 Sensor, offered by Tekscan, Inc. of South Boston, Mass. However, force sensors of other types may be employed, for example resistive sensors and capacitive sensors. Channels 218 extend between cavities 210 and 214 to accommodate power and signal cables. A non-slip layer 220 of an elastomeric material (e.g., rubber) is bonded to the underside of electronics housing 206 to prevent movement of pressure bar load sensor 200 on the floor of a warehouse or other facility where pressure bar load sensor 200 is installed.

FIG. 2C depicts components of pressure bar load sensor 200, including three force sensors 212 located within sensor and electronics housing 206, in contact with pressure plate 202 (not shown) and in communication with electronics 216 within center cavity 214 including a summing circuit with analog amplifier 222 in communication with microprocessor 224 (such term including associated memory and control logic) which is, in turn, in communication with Bluetooth transceiver 226. Power for pressure bar load sensor 200 may be provided by a rechargeable lithium battery 228, which may be located within the center cavity 214.

As shown in FIG. 2D, a system comprising Bluetooth transceivers 226 of multiple pressure bar load sensors 200 (the number shown being three by way of non-limiting example only) may be in communication with a base Bluetooth transceiver 300 in communication with a proximately located Ethernet to Bluetooth bridge 302 which, in turn, is in communication with a client server 304, which may be in communication with the local area network (LAN) of the warehouse or other location of the pressure bar load sensors 200. FIG. 2E shows additional detail of Ethernet to Bluetooth bridge 302 which may include base Bluetooth transceiver 300, microprocessor 303 (such term including associated memory and control logic) and an Ethernet port 306 for communication to client server 304 via a wired connection. It is contemplated that a WiFi connection may be employed in lieu of a wired connection.

In operation, a pallet 104 bearing an initial load of articles (e.g., cardboard box flats 106) is placed on a pressure bar load sensor 200. Force sensors 212 may be initialized responsive to pallet placement, or via a command signal received by Bluetooth transceiver 226 to provide a reference load magnitude. Microprocessor 224 of pressure bar load sensor 200 may also be preprogramed to anticipate a given initial load magnitude, such as heavy, medium or light, or a percentage (e.g., 100%, 75%, 50%) of maximum design load magnitude (i.e., pallet plus article load) to be supported by pressure bar load sensor 200. Microprocessor 224 may also, in this and other embodiments, be preprogrammed to deduct the pallet weight or an approximation thereof from the initial pallet load so that a more precise indication of pallet load reduction may be monitored.

As articles are removed from pallet 104, force sensors 212 may output signals corresponding to pallet load through summing circuit with analog amplifier 222 at predetermined intervals (e.g., every 5 minutes, every 15 minutes), microprocessor 224 then initiating corresponding signals via Bluetooth transceiver 226 when the summed output signals correspond to a triggering load magnitude. For example, microprocessor 224 may be programmed to cause an alert signal to be output via Bluetooth transceiver 226 when pallet load magnitude reaches 25% of an initial load magnitude, and an alarm signal if pallet load magnitude reaches 5% of an initial load magnitude if an operator has not temporarily disabled pressure bar load sensor 200 responsive to a replacement pallet being on site. Such an approach may save power consumption by maintaining force sensors 212 in an inactive state for a majority of time. In a further operational feature, the current pressure (i.e., load) state of the pressure bar load sensor 200 may be obtained at any time responsive to a command signal initiated from Ethernet to Bluetooth bridge 302.

In another implementation, force sensor 212 are in continuous operation, with microprocessor 224 monitoring force sensor output magnitudes substantial continuously or at predetermined intervals (e.g., every 5 minutes, every 15 minutes) and initial signal transmission by Bluetooth transceiver 226 corresponding to one or more of a predetermined magnitude, a rate of change of magnitude or one or more lower threshold magnitudes (i.e., as previously described).

In any of the above cases, the signals from Bluetooth transceiver 226 to base Bluetooth transceiver 300 are, in turn, received by an operator to initiate pallet replacement. The signals may be received at client server 304 over the facility LAN, by the client server 304 via a WiFi signal of the facility's WiFi system or, in some embodiments the Bluetooth signals may be received by a mobile device including a Bluetooth capability and programmed to function as a base Bluetooth transceiver 300. Further, data comprising the signals from Bluetooth transceiver may be stored by the client server 308 of the facility to monitor the need for replacement articles to be delivered outside the facility in a ready location.

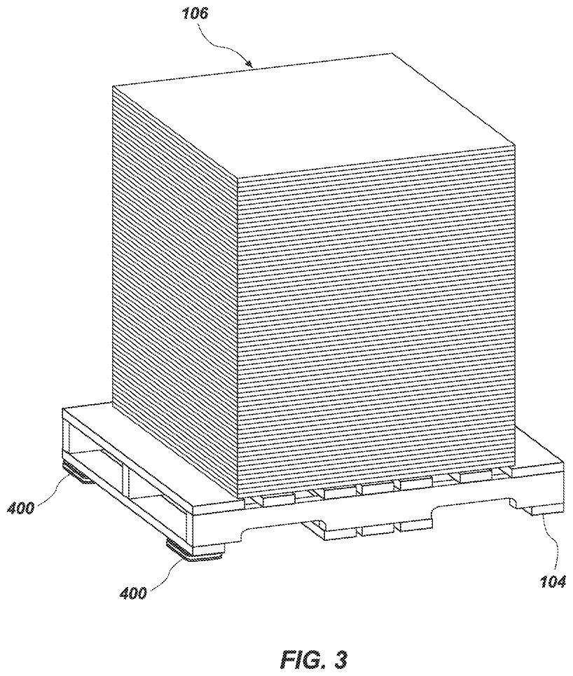

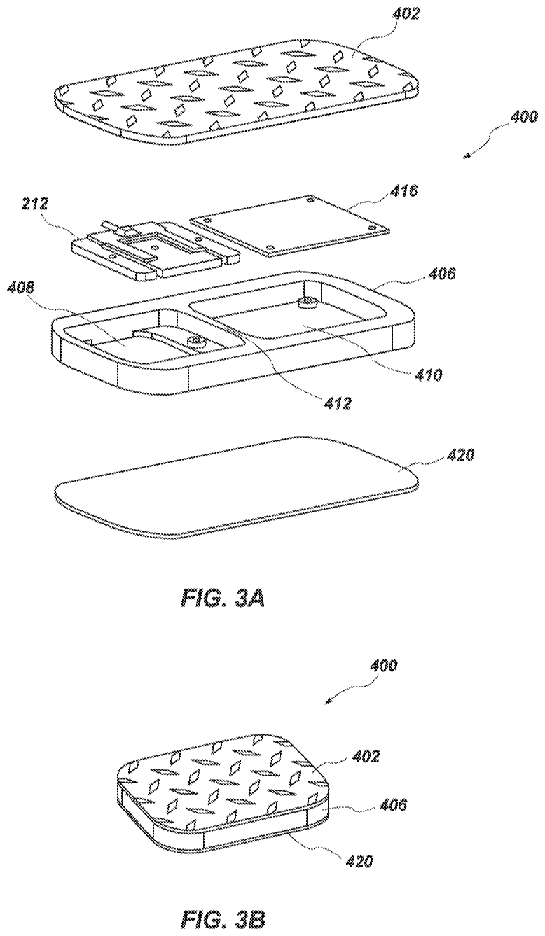

FIG. 3 depicts another embodiment of the disclosure in the form of pressure puck load sensor 400, which may be placed at opposing ends of a side of a pallet 104 loaded with cardboard box flats 106. As shown, pressure puck load sensors 400 may be located along a pallet side opposite a side where a pallet jack fork enters pallet 104, or may be located along a pallet side parallel to the direction of entry of a pallet jack fork, in a manner as previously shown with respect to pressure bar load sensor 200 in FIGS. 1A and 1B.

As shown in FIG. 3A and 3B, each pressure puck load sensor 400 includes a pressure plate (e.g., steel) 402 with a diamond pattern or other non-skid upper topography 404 for traction over a sensor and electronics housing 406 (e.g., aluminum) with upwardly facing recesses 408 and 410. Recess 408 houses a force sensor 212 in contact with pressure plate 402 and recess 410 houses electronics 416. Force sensor 212 and electronics 416 communicate through a channel (not shown extending through wall 412. As with pressure bar load sensor 200, force sensor 212 may be a piezoresistive force sensor, for example the FlexiForce™ A401 Sensor, offered by Tekscan, Inc. of South Boston, Mass. However, force sensors of other types may be employed, for example a resistive force sensor or a capacitive force sensor. A non-slip layer 420 of an elastomeric material (e.g., rubber) is bonded to the underside of electronics housing 406 to prevent movement of pressure puck load sensor 400 on the floor of a warehouse or other facility where pressure puck load sensor 400 is installed.

The electronics 416 of pressure puck load sensors 400 are similar to those described and illustrated with respect to pressure bar load sensor 200, with the exception that each pressure puck load sensor 400 may include a Bluetooth transceiver 226 and analog amplifier, while a summing circuit may be located in Ethernet to Bluetooth bridge 302. Alternatively, pressure puck load sensors 400 may be hard wired together in a master/slave relationship and summing circuit with analog amplifier 222 and a single microprocessor 224 included in a master pressure puck load sensor 400 along with a single power supply (e.g., lithium battery and a single Bluetooth transceiver 226 for communication with base Bluetooth transceiver 300. Communication between the two pressure puck load sensor 400 may, alternatively be effected using a short-range wireless bridge, in which instance each pressure puck load sensor 400 may be furnished with an independent power supply (e.g., lithium battery). Operation of pressure puck load sensors 400 in cooperation with base Bluetooth transceiver 300 and other components described above with respect to FIGS. 2C through 2E may be substantially the same as described with respect to pressure bar load sensors 200.

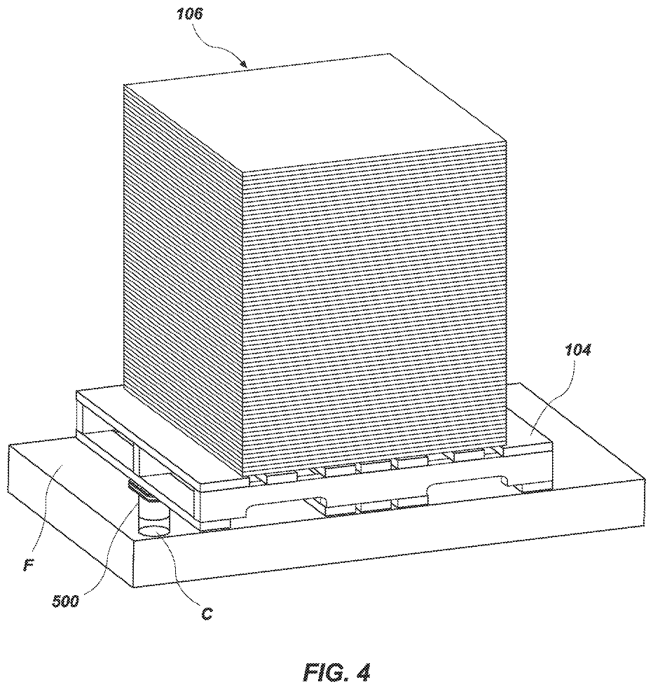

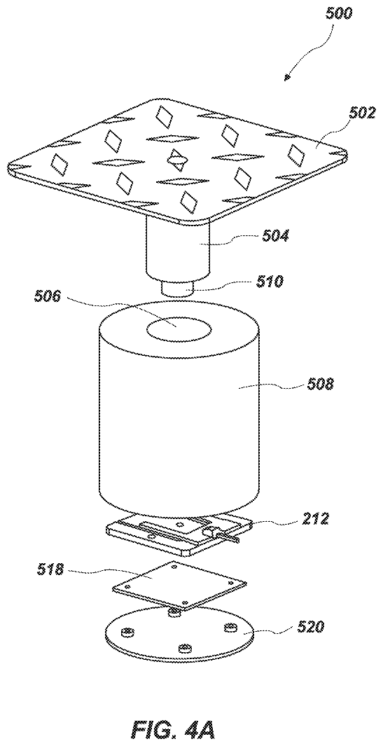

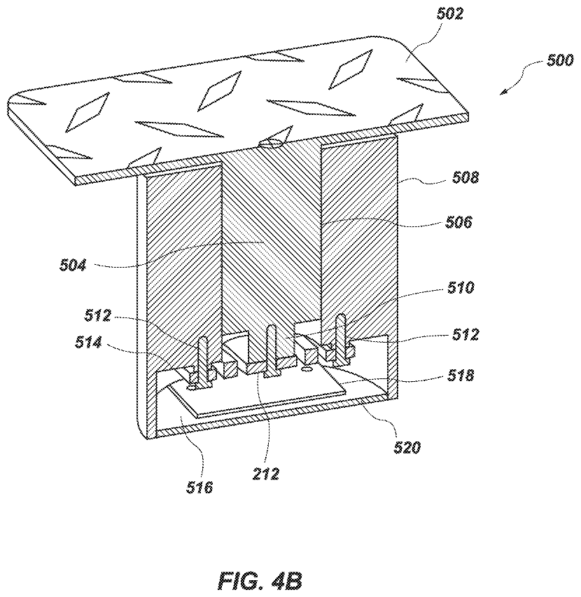

FIGS. 4 through 4B show another embodiment of the disclosure in the form of a floor-mounted canister scale load sensor 500 comprising a load cell. FIG. 4 shows a pallet 104 loaded with cardboard box flats 106 placed on floor F of a warehouse or other facility with a midpoint of a side of pallet 104 resting on canister scale load sensor 500, which is received in cylindrical cavity C opening onto the surface of floor F. FIGS. 4A and 4B shows details of a diamond-patterned or other non-skid pressure plate 502 (e.g., steel) to the underside of which a cylindrical load piston 504 is secured (e.g., as by welding). Load piston 504 is slidably housed within upper cylindrical bore 506 of load cell housing 508. Load contact 510 at the lower end of load piston 504 is aligned with force sensor 212, which may be a piezoresistive force sensor, for example the FlexiForce™ A401 Sensor, offered by Tekscan, Inc. of South Boston, Mass. However, force sensors of other types may be employed, for example resistive sensors and capacitive sensors. As shown in FIG. 4B force sensor 212 is secured with bolts 512 to shoulder surface 514 extending radially from the lower edge of upper cylindrical bore 506 to an upper extent of the wall of lower cylindrical bore 516, and load contact 510 is in contact with force sensor 212. Electronics 518 are located under force sensor 212 at the bottom of lower cylindrical bore 516 closed by floor plate 520, and include a lithium battery, analog amplifier and microprocessor (such term including associated memory and control logic), as well as a Bluetooth transceiver, similar to the assembly depicted and described with respect to FIG. 2C. In an alternative implementation, canister scale load sensor 500 may be mounted in a solid precast support structure having a cavity in its upper surface, in order to avoid having to form the cavity in the facility floor. Operation of floor mounted canister scale load sensor 500 in cooperation with base Bluetooth transceiver 300 and other components described above with respect to FIGS. 2D and 2E may be substantially the same as described with respect to pressure bar load sensors 200.

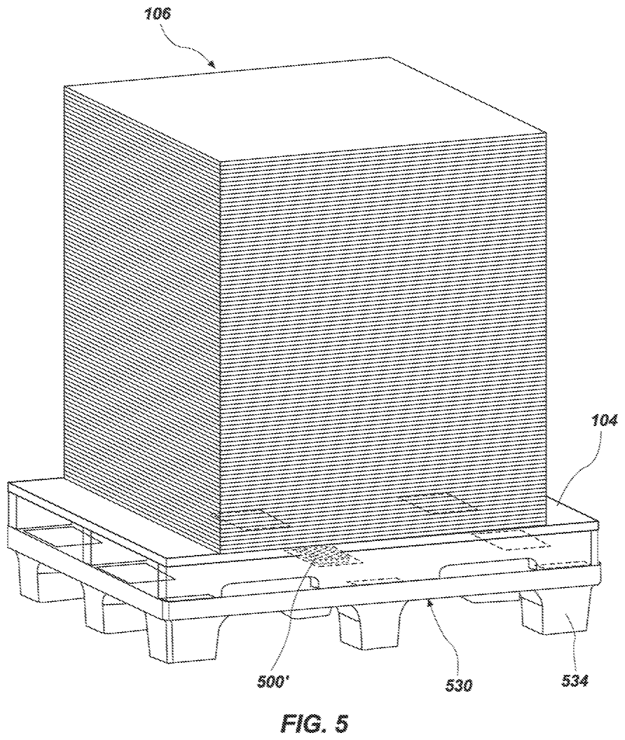

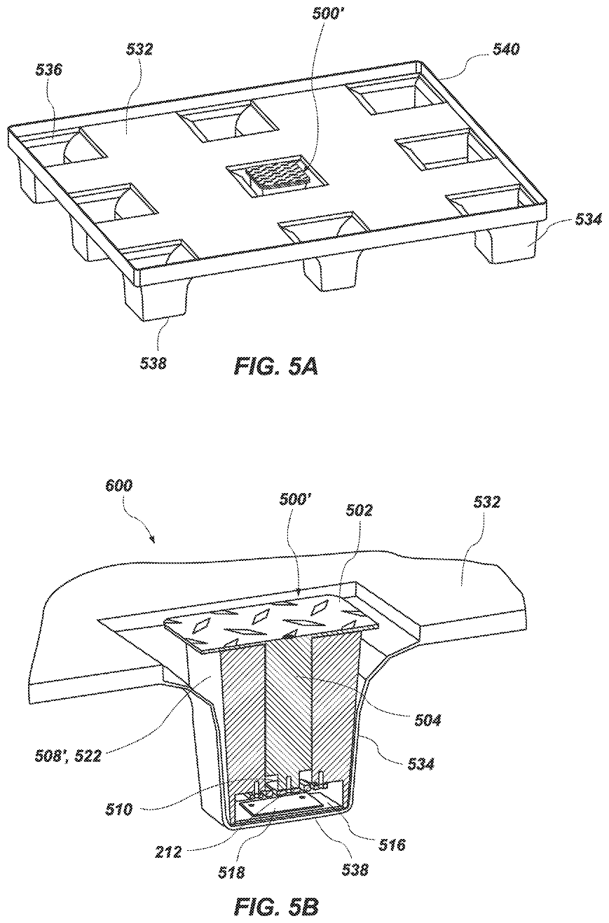

FIGS. 5 and 5A depict yet another embodiment of the disclosure using a canister scale load sensor 500′ substantially similar to canister scale load sensor 500 described above with respect to FIGS. 4 through 4B. As shown in FIG. 5, a stack of cardboard box flats 106 rests on pallet 104, which is supported by pallet support 530. As shown in more detail in FIG. 5A, pallet support 530 includes a deck 532 supported by nine hollow legs 534 which taper in width from openings 536 to deck 532 to floor 538. In one implementation, pallet support 530 may comprise a single, molded plastic article. Wall 540 extends upwardly from the periphery of deck 532 and, as shown in FIG. 5, may surround pallet 104 for stability. Canister scale load sensor 500′ includes the same components as canister scale load sensor 500 identified with like numbers, the exception being load cell housing 508′, which is of rectangular shape and exhibits a tapered longitudinal outer surface 522 which matches an interior size and taper of center leg 534. Canister scale load sensor 500′ rests on floor 538 of center leg 534 and is constrained from lateral movement by a friction (e.g., interference) fit of load cell housing 508′ with interior surface 540 of center leg 534. Operation of pallet support-mounted canister scale load sensor 500′ in cooperation with base Bluetooth transceiver 300 and other components described above with respect to FIGS. 2C through 2E may be substantially the same as described with respect to pressure bar load sensors 200.

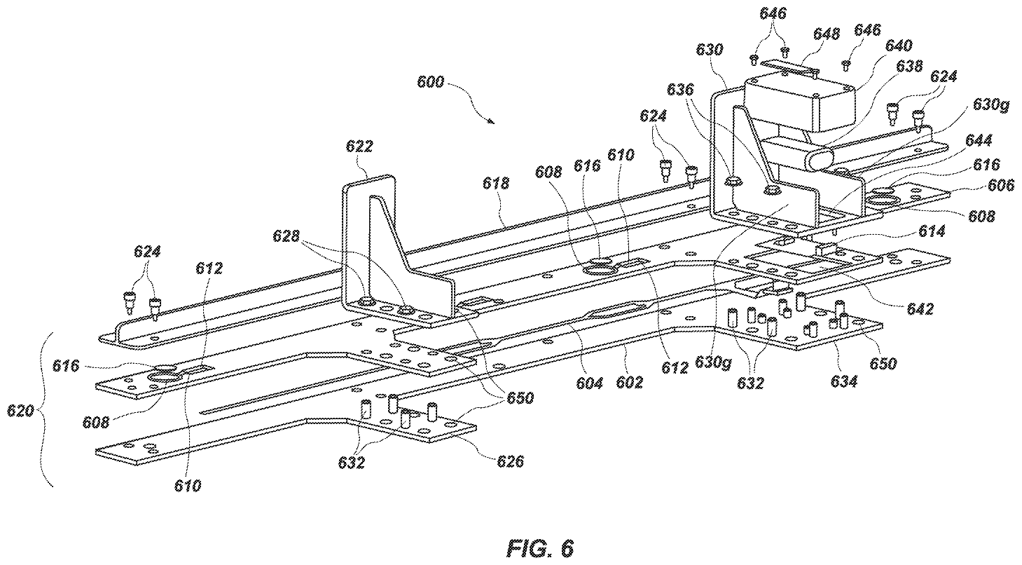

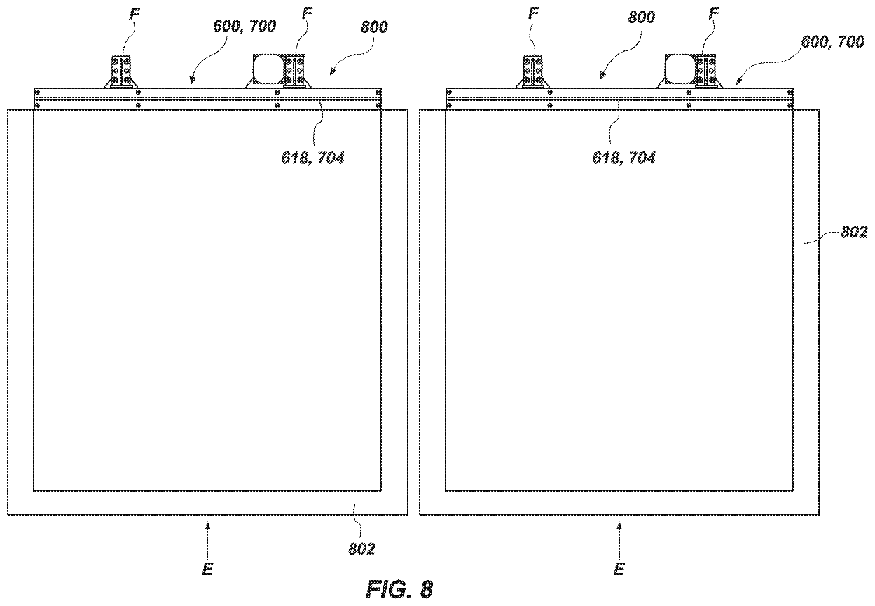

FIG. 6 depicts yet another embodiment of the disclosure in the form of a pressure bar load sensor 600 configured for installation at the rear of a pallet storage cell 800 as shown in FIG. 8. Pressure bar load sensor 600 includes a base plate 602 of, for example, steel over which is disposed a flex circuit 604, over which protective sheet 606 of, for example, aluminum is laid. Protective sheet 606 carries multiple (e.g., four) longitudinally spaced load sensors in apertures in protective sheet 606, each of which load sensors 608, which may comprise FlexiForce™ A401 Sensors, offered by Tekscan, Inc. of South Boston, Mass., is electrically connected to conductive traces of flex circuit 604 with flex cables 610 extending through apertures 612 in protective sheet 606. Flex circuit 604 is, in turn, electrically connected to sensor control board 614. A load concentrator puck 616 is placed over each load sensor 608. T-bar 618 of, for example, aluminum is placed over protective sheet 606 and base plate 602, protective sheet 606 and T-bar 618 are secured together in a laminated assembly 620 using fasteners 624 in the form of, for example, shoulder screws. Single gusset back stop 622 is secured to laminated assembly 620 with threaded studs 632 protruding vertically from flange 626 of base plate 602 extending through aligned apertures of protective sheet 606 and single gusset back stop 622 and made up with nuts 628. Similarly, double gusset back stop 630 is secured to laminated assembly 620 with threaded studs 632 protruding vertically from flange 634 of base plate 602 extending through aligned apertures of protective sheet 606 and double gusset back stop 630 and made up with nuts 636. Sensor control board 614 and battery pack 638 are enclosed in controller enclosure 640, residing partially in aligned apertures 642 of protective sheet 606 and 644 of double gusset back stop 630 between parallel gussets 630g. Flanges 626 and 634, protective sheet 606, single gusset back stop 622 and double gusset back stop 630 include aligned apertures 650 through which fasteners (not shown) in the form of cement anchors may be used to secure pressure bar load sensor 600 to a facility floor.

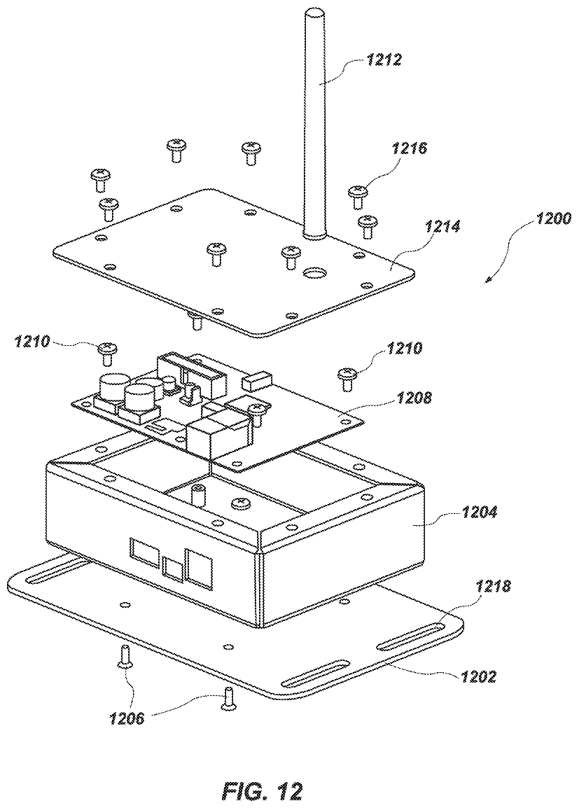

Sensor control board 614 is electrically connected to battery pack 638, both being secured by screws 646 in controller enclosure 640. Bluetooth antenna 648 may be located on the top of controller enclosure 640 as shown, or on the underside of the enclosure, and electrically connected to sensor control board 614. Sensor control board 614 includes an analog amplifier and microprocessor (such term including associated memory and control logic) and a Bluetooth transceiver to receive and process pressure information from load sensors 608. Communication is effected between sensor control board 614 through Bluetooth antenna 648 with a remote Bluetooth to Ethernet Bridge Controller (not shown, see FIG. 12) including a Bluetooth transceiver by Bluetooth low energy (BLE) 2.4 GHz signals. Pressure bar load sensor 600 may be powered by 3.7 volt 2600 mAh protected Lithium-Ion cells, with an estimated life of 18 months. The battery pack 638 may comprise a single two cell pack as shown, or two single cell battery packs in a series configuration to increase voltage for the analog portion of the senor control board circuits to approximately 7.4 volts, while the remainder of the circuits are connected to a single cell and run on 3.7 volts.

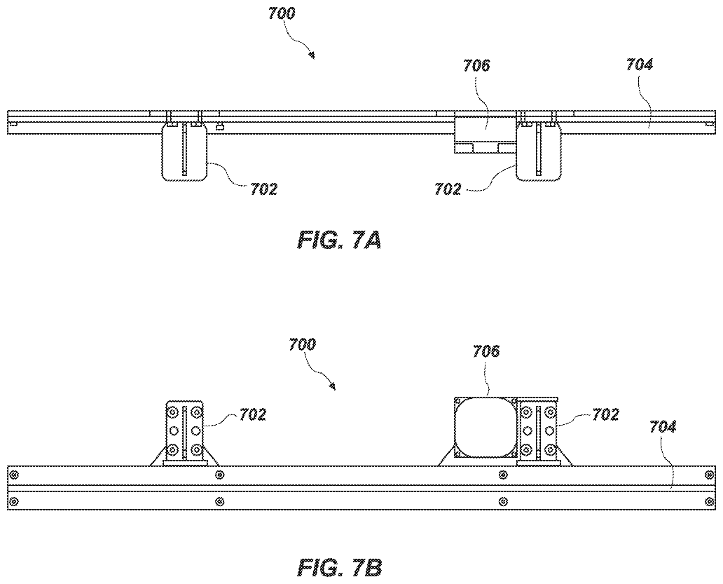

As shown in FIGS. 7A and 7B, another variant of pressure bar load sensor 700 of the embodiment of FIG. 6 employs two longitudinally spaced single gusset back stops 702 behind T-bar 704 under which load sensors (not shown) are installed. An electronics module 706 with a wireless controller (sensor control board, battery pack, Bluetooth antenna) is located laterally adjacent to one of the single gusset back stops 702. The viewer will note that the location of the electronics module 706 in FIGS. 7A and 7B is reversed from the location of similar components in the FIG. 6 embodiment, such locational variations being immaterial to operation. However, the double gusset back stop of the FIG. 6 embodiment provides additional physical protection to controller enclosure.

FIG. 8 is a top view of an example arrangement of two storage cells 800, defined on the floor of a warehouse or manufacturing facility by, for example, tape borders 802 adhered to the floor. A pressure bar load sensor 600 or 700 (the latter shown) is installed at the rear of each storage cell 800, and secured in place with multiple (e.g., four) cement anchors extending through flanges F of gusset back stops (622, 630 or 702) into the cement floor. In use, a pallet jack as previously described carries a loaded pallet into a storage cell 800 from the entrance of the storage cell 800 indicated by arrow E until the pallet contacts the back stops after passing over the T-bar 618, 704, after which the pallet is lowered to the floor and contacts pressure bar load sensor 600 or 700 on the vertically upstanding body of the “T” of the T-bar 618, 704. Load sensing and signal transmission from the pressure bar load sensor 600, 700 under a pallet load then commences as described above. Operation of pressure bar load sensors in cooperation with base Bluetooth transceiver and other components described above with respect to FIGS. 2C through 2E and employed in Bluetooth to Ethernet Bridge Controller of FIG. 12 may be substantially the same as described with respect to pressure bar load sensor 200.

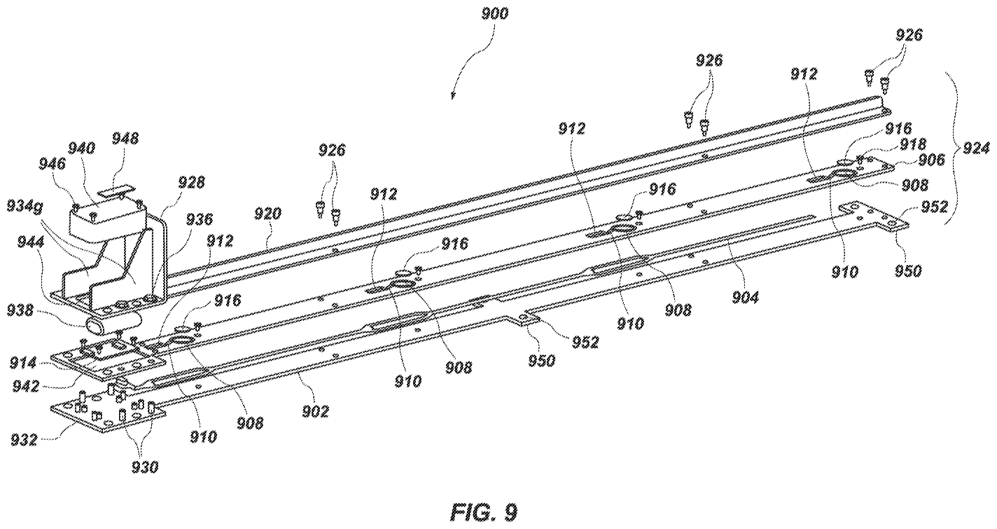

FIG. 9 depicts yet a further embodiment of the disclosure in the form of a pressure bar load sensor 900 configured for installation at the side of a pallet storage cell. Pressure bar load sensor 900 includes a base plate 902 of, for example, steel over which is disposed a flex circuit 904, over which protective sheet 906 of, for example, aluminum is laid. Protective sheet 906 carries multiple (e.g., four) longitudinally spaced load sensors 908, which may comprise FlexiForce™ A401 Sensors offered by Tekscan, Inc. of South Boston, Mass., in apertures in protective sheet 906, each of which load sensors 908 is electrically connected to conductive traces of flex circuit 904 with flex cables 910 extending through apertures 912 in protective sheet 906. Flex circuit 904 is, in turn, electrically connected to sensor control board 914. A load concentrator puck 916 is placed over each load sensor 908. Protective sheet 906 may be secured to base plate 902 with multiple fasteners 918 in the form of, for example, flathead screws. T-bar 920 of, for example, aluminum is placed over protective sheet 906 and base plate 902, protective sheet 906 and T-bar 920 are secured together in a laminated assembly 924 using fasteners 926 in the form of, for example, shoulder screws. Double gusset back stop 928 is secured to laminated assembly 924 with threaded studs 930 protruding vertically from pad 932 at an end of base plate 902 extending through aligned apertures of protective sheet 906 and double gusset back stop 928 and made up with nuts 936. Flanges 950 at one end and in the middle of the assembly, and pad 932 at another end of base plate 902 include apertures 952 through which fasteners (not shown) in the form of cement anchors may be used to secure pressure bar load sensor 900 to a facility floor.

Sensor control board 914 and battery pack 938 are enclosed in controller enclosure 940, residing partially in aligned apertures 942 of protective sheet 906 and 944 of double gusset back stop 928 between parallel gussets 934g. Sensor control board 914 is electrically connected to battery pack 938, both being secured by screws 946 in controller enclosure 940. Bluetooth antenna 948 may be located on the top of controller enclosure 940 as shown, or on the underside of the enclosure, and electrically connected to sensor control board 914. Sensor control board 914 includes an analog amplifier, a microprocessor (such term including associated memory and control logic) and a Bluetooth transceiver to receive and process pressure information from load sensors 908. Communication is effected between sensor control board 914 through Bluetooth antenna 948 with a remote Bluetooth to Ethernet Bridge Controller (not shown, see FIG. 12) by Bluetooth low energy (BLE) 2.4 GHz signals. Pressure bar load sensor 900 may be powered by 3.7 volt 2600 mAh protected Lithium-Ion cells, with an estimated life of 18 months. The battery pack 638 may comprise a single two cell pack as shown, or two single cell battery packs in a series configuration to increase voltage for the analog portion of the senor control board circuits to approximately 7.4 volts, while the remainder of the circuits are connected to a single cell and run on 3.7 volts.

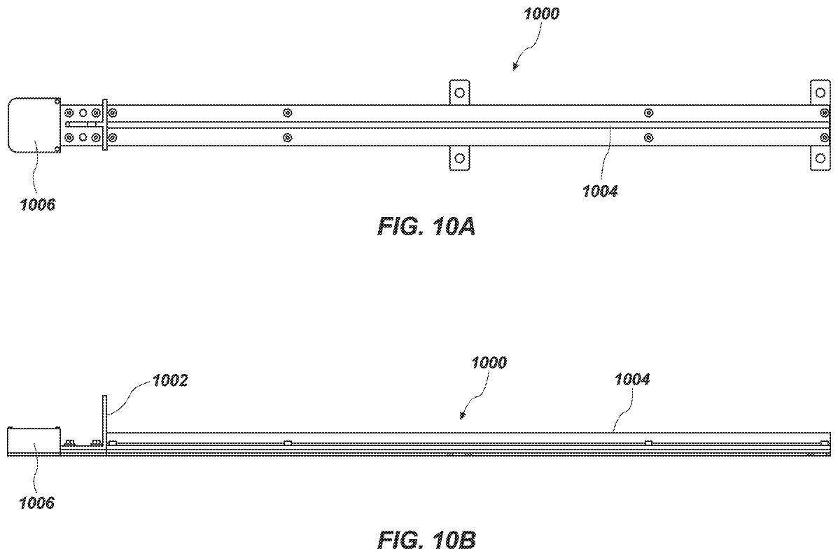

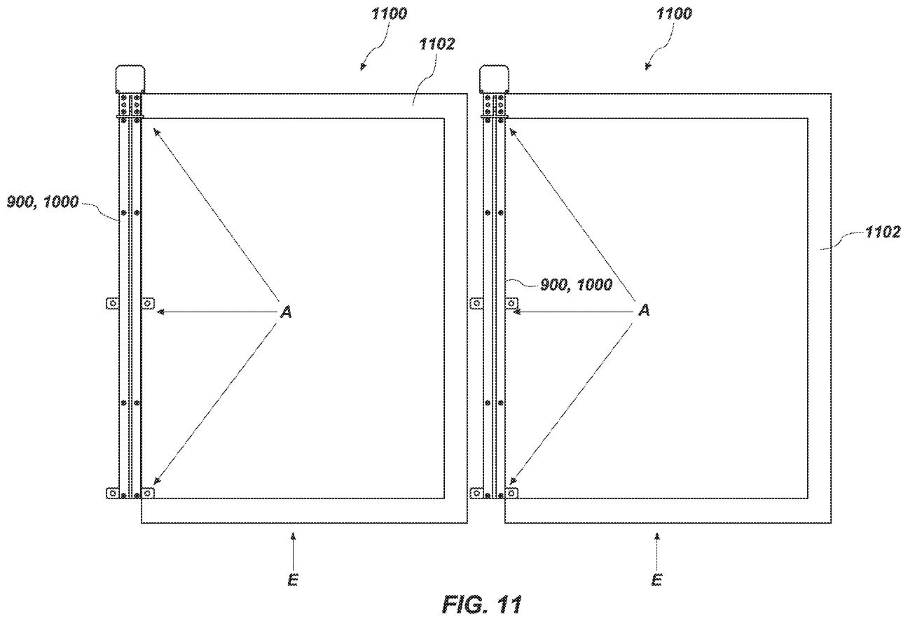

As shown in FIGS. 10A and 10B, a variant 1000 of the pressure bar load sensor embodiment of FIG. 9 employs a single gusset back stop 1002 at one end of T-bar 10004 under which load sensors (not shown) are installed. An electronics module 1006 with a wireless controller (sensor control board, battery pack, Bluetooth antenna) is located single gusset back stop 1002. The viewer will note that the location of the electronics module 1006 in FIGS. 10A and 10B is similar to, but slightly different from the location of the FIG. 9 embodiment, such locational variations being immaterial to operation. However, the double gusset back stop of the FIG. 9 embodiment provides additional physical protection to the electronics module.

FIG. 11 is a top view of an example arrangement of two storage cells 1100, defined on the floor of a warehouse or manufacturing facility by, for example, tape borders 1102 adhered to the facility floor. A pressure bar load sensor 900 or 1000 (the latter shown) is installed at the side of each storage cell 1100, and secured in place with multiple (e.g., six) cement anchors at locations indicated by arrows A into the cement floor. In use, a pallet jack as previously described carries a loaded pallet into a storage cell 1100 from the entrance of the storage cell 1100 indicated by arrow E, parallel to and with a side pallet edge over pressure bar load sensor 900 or 1000 until the pallet contacts the back stop, after which the pallet is lowered to the floor and contacts pressure bar load sensor 900 or 1000 on the vertically upstanding body of the “T” of the T-bar. Load sensing and signal transmission from the pressure bar under a pallet load then commences as described above. Operation of pressure bar load sensors 900, 1000 in cooperation with base Bluetooth transceiver and other components described above with respect to FIGS. 2C through 2E and employed in Bluetooth to Ethernet Bridge Controller of FIG. 12 may be substantially the same as described with respect to pressure bar load sensor 200.

Notably, with pressure bar load sensors 900 and 1000, the design allows a pallet jack at a high setting carrying a pallet load to pass over the top of the back stop and place a pallet behind the pressure bar for storage. This feature may be particularly advantageous for locations which have storage in the form of a lane. When a pallet in the storage cell is depleted and removed, an additional fully loaded pallet which has been placed behind the cell may be lifted over the back stop, moved forward into the storage cell and placed on the pressure bar using the back stop.

Referring now to FIG. 12, Bluetooth to Ethernet Bridge Controller 1200 suitable for use with the pressure bars and other embodiments is depicted. Controller mount plate 1202 supports controller enclosure 1204, which is secured to controller mount plate 1202 with fasteners 1206 in the form of, for example, flathead screws. Control board 1208 including a microprocessor (such term including associated memory and control logic),and an Ethernet port for communication to a client server via a wired connection or a WiFi transceiver, is received within controller enclosure 1204 and secured within by fasteners 1210 in the form of screws. Bluetooth antenna 1212 extends through an aperture in controller lid 1214 and is electrically connected to control board 1208. Controller lid 1214 is secured to controller enclosure 1204 by fasteners 1216 in the form of screws. Slots 1218 in controller mount plate 1202 allow the Ethernet Bridge Controller 1200 to be mounted securely in place, remote from storage cells. Power is supplied to Ethernet Bridge Controller 1200 from an external source, and controller is connected to a facility LAN network using an Ethernet cable. In some embodiments, the Bluetooth to Ethernet Bridger Controller 1200 may use Power Over Internet (POE) as a power source when connected to a switch that supports POE. Such an approach simplifies wiring to a single CAT 5, 5E, 6, etc., type cable for power and communications.

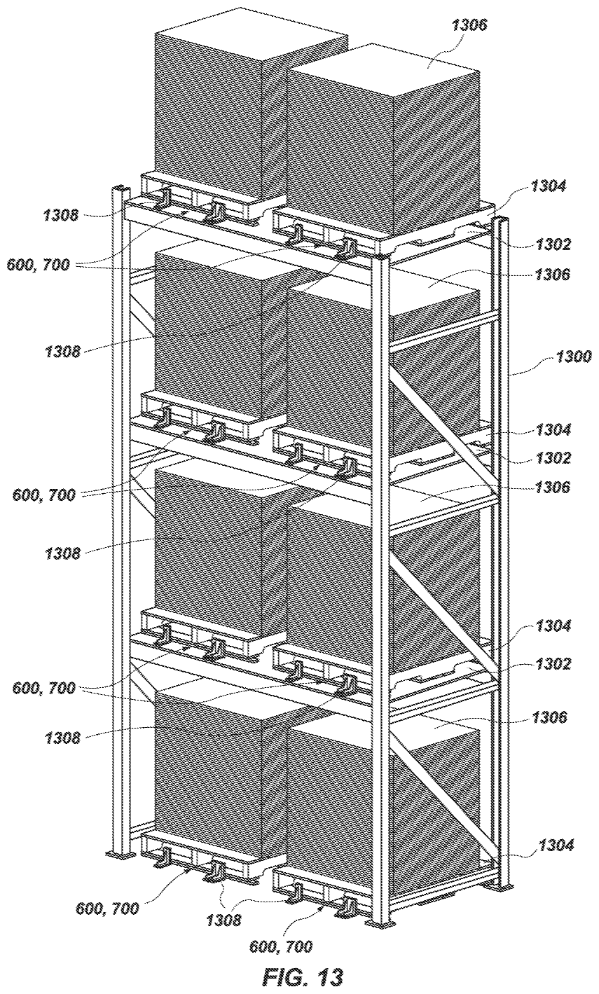

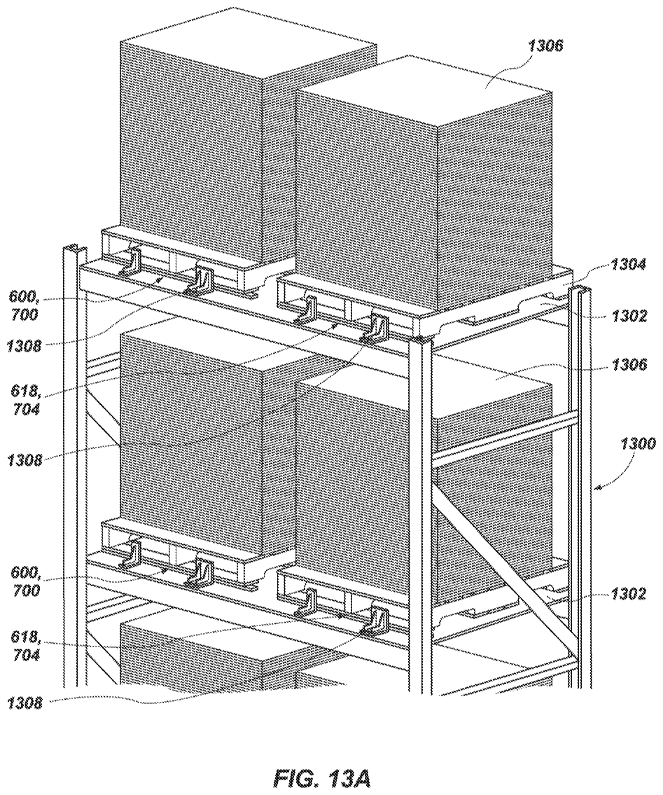

Referring to FIGS. 13 and 13A, pressure bar load sensors 600, 700 are shown secured to shelves 1302 of a multi-level rack assembly 1300, each pressure bar load sensor 600, 700 located under a side (i.e., end) of a pallet 1304 loaded with articles 1306 (e.g., cardboard box flats) and which has been inserted onto a storage cell area of a shelf 1302 from another side of the multi-level rack assembly 1300 opposite the respective pressure bar load sensor 600, 700 until contact is made with back stops 1308 (which correspond respectively to previously described back stops 622, 630 and 702). As shown in FIG. 13A, a side (i.e., end) of each pallet 1304 is supported on a T-bar 618, 704 not shown of an associated pressure bar load sensor 600, 700. With such an arrangement, storage of pallet-loaded articles within a facility may be enhanced for a given area of floor space, and different size of articles (e.g., cardboard box flats) may be stored in a relatively compact area. Further, such an arrangement may be compatible with, for example, a robotic article retrieval system configured for removal of articles from different pallets at different levels of the multi-level rack assembly 1300.

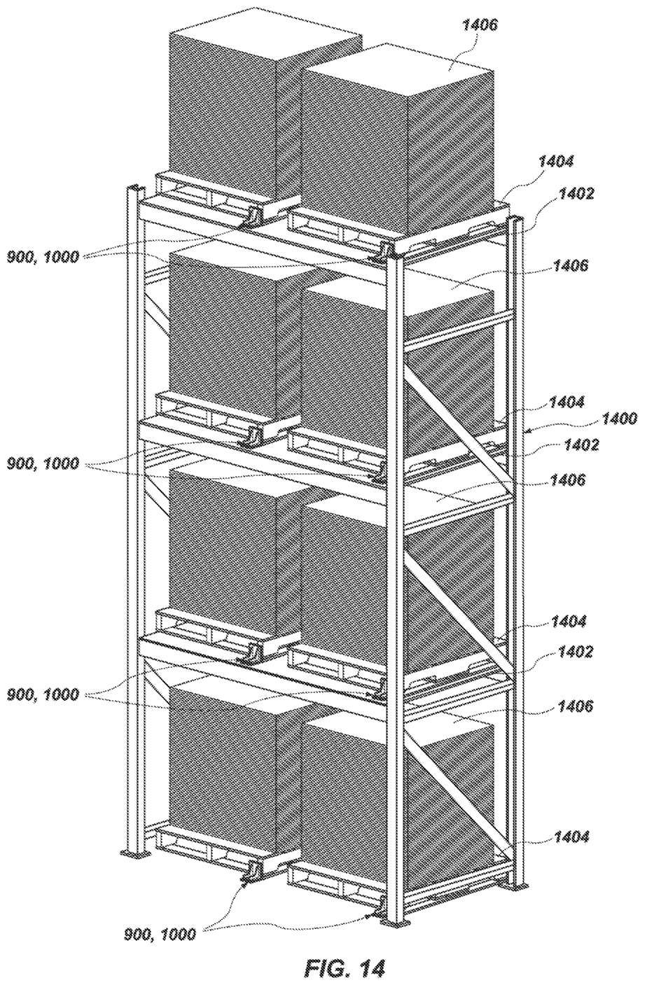

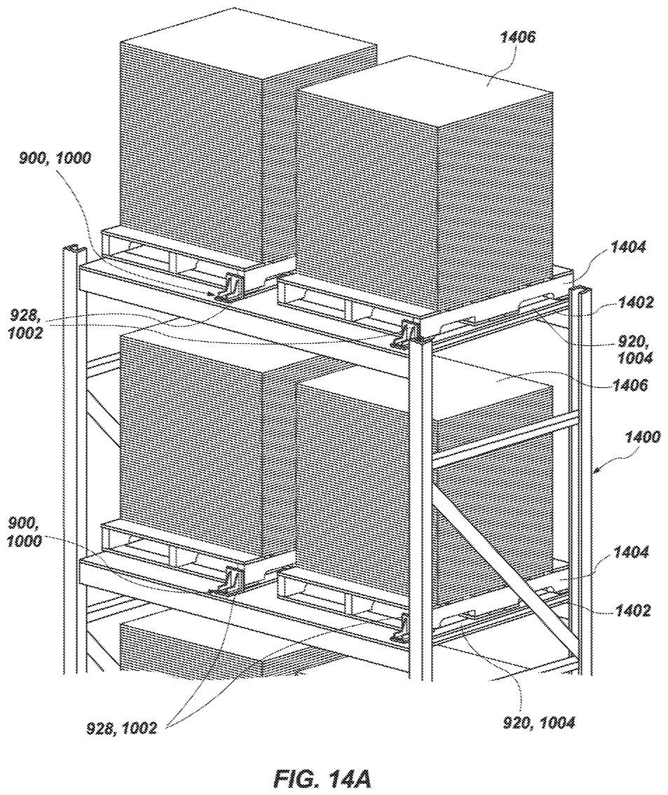

Referring to FIGS. 14 and 14A, pressure bar load sensors 900, 1000 are shown secured to shelves 1402 of a multi-level rack assembly 1400, each pressure bar load sensor 900, 1000 located under a side of a pallet 1404 loaded with articles 1406 (e.g., cardboard box flats) and which has been inserted onto a storage cell area of a shelf 1402 from another side of the multi-level rack assembly 1300 opposite the side of multi-level rack assembly 1400 visible in the drawing figure until contact is made with double gusset back stop 928 or single gusset back stop 1002. As shown in FIG. 14A, a side of each pallet 1304 is supported on a T-bar 920, 1004 of an associated pressure bar load sensor 900, 1000. With such an arrangement, as with the embodiment of FIGS. 13 and 13A, storage of pallet-loaded articles within a facility may be enhanced for a given area of floor space, and different size of articles (e.g., cardboard box flats) may be stored in a relatively compact area. Further, such an arrangement may be compatible with, for example, a robotic article retrieval system configured for removal of articles from different pallets at different levels of the multi-level rack assembly 1400.

As used herein, the term “pallet jack” is to be construed in a broad sense, to include not only various types of pallet jack products (e.g., manual and electric pallet jacks and trucks) but also forklifts (e.g., electric and internal combustion) and other apparatus for lifting and moving palletized loads from one location to another.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the terms “longitudinal,” “vertical,” “lateral,” and “horizontal” are in reference to a major plane of a substrate (e.g., base material, base structure, base construction, etc.) in or on which one or more structures and/or features are formed and are not necessarily defined by earth's gravitational field. A “lateral” or “horizontal” direction is a direction that is substantially parallel to the major plane of the substrate, while a “longitudinal” or “vertical” direction is a direction that is substantially perpendicular to the major plane of the substrate. The major plane of the substrate is defined by a surface of the substrate having a relatively large area compared to other surfaces of the substrate.

As used herein, spatially relative terms, such as “beneath,” “below,” “lower,” “bottom,” “above,” “over,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “over” or “above” or “on” or “on top of” other elements or features would then be oriented “below” or “beneath” or “under” or “on bottom of” the other elements or features. Thus, the term “over” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the terms “configured” and “configuration” refer to a size, shape, material composition, orientation, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

As used herein, the terms “layer” and “film” mean and include a level, sheet or coating of material residing on a structure, which level or coating may be continuous or discontinuous between portions of the material, and which may be conformal or non-conformal, unless otherwise indicated.

As used herein, the term “may” with respect to a material, structure feature or method act indicates that such is contemplated for use in implementation of an embodiment of the disclosure and such term is used in preference to the more restrictive term “is” so as to avoid any implication that other compatible materials, structures, features and method acts usable in combination therewith should or must be excluded.

As used herein, the term “side” as relating to an edge or a structure extending along a periphery of a pallet means and includes a side or an end of the pallet. Thus, a pallet may have four sides, each side joined at ends to end of two other perpendicular sides, or two mutually parallel sides and two mutually parallel ends perpendicular to the two sides.

As used herein, the term “housing” may mean a single article configured for carrying components of the embodiments of the disclosure, or multiple articles combined in an assembly for carrying such components.

As used herein, the term “floor” as applied to a structure or surface supporting a load sensor of an embodiment of the disclosure means and includes not only a facility floor per se, but any support surface include a shelf of a rack assembly or other support structure presenting a horizontal surface sized, configured and of sufficient strength for supporting a pallet.

Those of ordinary skill in the art will appreciate that embodiments of the present disclosure afford a load monitoring capability without the need for precision article inventory monitoring, in an inexpensive and robust form easily implementable without the use of custom components. Further, groups of load sensors according to embodiments of the disclosure may be rapidly installed in any desired number and pattern on a facility floor without any physical facility modification, and may be rearranged as desired or removed for repair and/or replacement. Notably, embodiments of the disclosure allow for minimization of pallet area on a facility floor in combination with rapid pallet replacement capability from a remote site outside yet close to the warehouse or other facility.

While described in terms of use with pallets loaded with cardboard box flats, embodiments of the disclosure are not so limited, and offer applicability with pallets or other support structures loaded with other articles, which may or may not be substantially the same. In other words, while embodiments of the disclosure are described to have utility in conjunction with pallets loaded with a single type, size or weight of article, these embodiments are not so limited. For example, a pallet may be loaded with a mixed load of different sizes (and associated weights) of the same type article, or with different types (and associated weights) of articles. In one example, a pallet may be loaded with containers of different volumes or densities of liquid. In another example, the pallet may be loaded with a number of different components to be assembled by an operator in a manufacturing facility, for example engine components for one or more engines, or appliance components for one or more appliances. In any of the foregoing cases, once a pallet is disposed on a load sensor of an embodiment, the fully loaded pallet provides a base weight X (which may be precalibrated to deduct a pallet weight), and the load sensor is programmed to provide alerts as the pallet load weight is reduced by, for example, 50%, 75%, etc., as articles are removed so that a new pallet may be requisitioned in a timely manner.

In a more sophisticated implementation of embodiments of the disclosure for use with a pallet loaded with articles of different weights, a weight of each different type or size of article on such pallet may be programmed in the microprocessor for that load sensor so that removal of a particular type or size of article may be detected and signaled, and a running tally kept for each type or size of article removed against an initial load number and a lower, threshold load number for signaling a need for replacement of that particular article. Further, if a pallet is loaded with identical groups of different components to be assembled, the weight of a pallet may be automatically deducted (i.e., the load sensor microprocessor preprogrammed) from the initial weight of the loaded pallet, and the weight of an individual component group may be programmed in the microprocessor for that load sensor with instructions to signal when only a predetermined number of component groups (e.g., three, two, one) remain on the pallet.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

What is claimed is:

1. An apparatus for monitoring a magnitude of a load on a pallet, comprising:
at least one housing carrying at least one force sensor configured and positioned to provide output signals corresponding to magnitudes of the load relative to a number of articles resting on the pallet;
the at least one housing configured for placement under a single side of the pallet, under substantially a center point of a single side of the pallet, or within the pallet under substantially a center point of the load.

2. The apparatus of claim 1 further comprising a Bluetooth transceiver carried by the at least one housing for communicating signals corresponding to the output signals from the at least one force sensor to a remote location.

3. The apparatus of claim 2, wherein the at least one force sensor is in communication with an analog amplifier and a microprocessor in communication with the Bluetooth transceiver, the microprocessor programmable to one or more of:
send an inquiry to the at least one force sensor to initiate an output signal at predetermined intervals; or
monitor magnitudes of the output signal of the at least one force sensor either substantially continuously or at predetermined intervals and initiate transmission of a signal by the Bluetooth transceiver corresponding to one or more of a predetermined change in magnitude, a rate of change of magnitude or a lower threshold magnitude; or
monitor magnitudes of the output signal of the at least one force sensor responsive to a command received by the Bluetooth transceiver from the remote location.

4. The apparatus of claim 3, wherein the housing carries a rechargeable power supply for the at least one force sensor, the analog amplifier, the microprocessor and the Bluetooth transceiver.

5. The apparatus of claim 1, further comprising a pressure plate extending over at least a portion of the housing in contact with the at least one force sensor and a non-slip material under and bonded to the housing.

6. The apparatus of claim 2, wherein the at least one housing comprise a single, substantially linear housing, the at least one force sensor comprises two or more substantially evenly longitudinally spaced force sensors carried by the single housing in communication through a summing circuit with an analog amplifier and a microprocessor in communication with the Bluetooth transceiver, the microprocessor programmable to one or more of:
send an inquiry to the at least one force sensor to initiate an output signal at predetermined intervals; or
monitor magnitudes of the output signal of the at least one force sensor either substantially continuously or at predetermined intervals and initiate transmission of a signal by the Bluetooth transceiver corresponding to one or more of a predetermined change in magnitude, a rate of change of magnitude or a lower threshold magnitude; or
monitor magnitudes of the output signal of the at least one force sensor responsive to a command received by the Bluetooth transceiver from the remote location.

7. The apparatus of claim 2, wherein the at least one housing comprises two separate housings, each carrying a force sensor and positionable under and proximate to an opposing end of a single side of the pallet, wherein each force sensor is in communication with an analog amplifier and a microprocessor in communication with the Bluetooth transceiver of its respective housing, the microprocessor carried by each housing programmable to one or more of:
send an inquiry to the force sensor to initiate an output signal at predetermined intervals; or
monitor magnitudes of the output signal of the force sensor either substantially continuously or at predetermined intervals and initiate transmission of a Bluetooth signal by the Bluetooth transceiver corresponding to one or more of a predetermined change in magnitude, a rate of change of magnitude or a lower threshold magnitude; or
monitor magnitudes of the output signal of the at least one force sensor responsive to a command received by the Bluetooth transceiver from the remote location.

8. The apparatus of claim 2, wherein the at least one housing comprises two separate housings, each carrying a force sensor and positionable under and proximate an opposing end of a single side of the pallet, wherein each force sensor is in communication with a summing circuit, an analog amplifier, a microprocessor and a Bluetooth transceiver carried by one of the two separate housings, the microprocessor programmable to one or more of:
send an inquiry to each force sensor to initiate an output signal at predetermined intervals; or
monitor magnitudes of the output signal of the at least one force sensor either substantially continuously or at predetermined intervals and initiate transmission of a signal by the Bluetooth transceiver corresponding to one or more of a predetermined change in magnitude, a rate of change of magnitude or a lower threshold magnitude; or
monitor magnitudes of the output signal of the at least one force sensor responsive to a command received by the Bluetooth transceiver from the remote location.

9. The apparatus of claim 8, wherein the housing carrying the summing circuit, analog amplifier, microprocessor and Bluetooth transceiver is in communication with the force sensor of the other housing through a cable or a wireless bridge.

10. A system for monitoring a magnitude of loads on multiple pallets, comprising:
two or more load sensors, each carrying:
at least one force sensor configured and positioned to provide output signals corresponding to magnitudes of the load relative to a number of articles resting on one pallet of the multiple pallets; and
a self-contained power supply;
at least one Bluetooth transceiver operably coupled to a load sensor associated with a pallet thereon;
each of the two or more load sensors configured for placement under a single side of a pallet or under substantially a center point of a single side of a pallet.

11. The system of claim 10, wherein the at least one force sensor carried by each of the two or more load sensors is in communication with an analog amplifier and a microprocessor in communication with the at least one Bluetooth transceiver, the microprocessor programmable to one or more of:
send an inquiry to the at least one force sensor to initiate an output signal at predetermined intervals; or
monitor magnitudes of the output signal of the at least one force sensor either substantially continuously or at predetermined intervals and initiate transmission of a signal by the Bluetooth transceiver corresponding to one or more of a predetermined change in magnitude, a rate of change of magnitude or a lower threshold magnitude; or
monitor magnitudes of the output signal of the at least one force sensor responsive to a command received by the Bluetooth transceiver from the remote location.

12. The system of claim 11, further comprising:
a base Bluetooth transceiver for communication with each of the at least one Bluetooth transceiver of each of the two or more load sensors.

13. The system of claim 12, wherein the base Bluetooth transceiver is in communication with an Ethernet to Bluetooth bridge for communication to a client server through a LAN.

14. A method of monitoring pallet loads, the method comprising:
sensing a load on a pallet with a load sensor comprising one or more force sensors located under a single side of the pallet.

15. The method of claim 14, further comprising locating the load sensor under and along a single side of the pallet.

16. The method of claim 14, further comprising locating the load sensor is located at a midpoint of a single side of the pallet.

17. The method of claim 14, further comprising the one or more force sensors sending output signals corresponding to changes in the load on the pallet, and the load sensor transmitting Bluetooth signals corresponding to changed pallet loads.

18. The method of claim 17, further comprising controlling transmission of the Bluetooth signals with a microprocessor of the load sensor.

19. The method of claim 18, wherein the load sensor comprises two or more spaced force sensors, and further comprising summing the output signals of the two or more spaced force sensors prior to transmission of the Bluetooth signals.

20. The method of claim 18, further comprising generating Bluetooth output signals corresponding to predetermined output signal magnitudes, rate of change of signal magnitude, or a lower threshold signal magnitude.

21. An apparatus for monitoring a magnitude of a load on a pallet, comprising:
a longitudinally extending pressure bar carrying two or more longitudinally spaced and mutually connected force sensors;
a longitudinally extending bar member on top of the longitudinally extending pressure bar and comprising a vertically upstanding, longitudinally extending body; and
at least one back stop adjacent the longitudinally extending bar member positioned for locating a side of a pallet over the longitudinally extending bar member when contacted by the pallet.

22. The apparatus of claim 21, wherein the at least one back stop is one back stop, the one back stop located proximate an end of the longitudinally extending pressure bar and facing the longitudinally extending bar member.

23. The apparatus of claim 21, wherein the at least one back stop comprises at least two back stops, the at least two back stops longitudinally separated along the longitudinally extending pressure bar between ends thereof, the at least two back stops facing and behind the longitudinally extending bar member.

24. The apparatus of claim 21, wherein the longitudinally extending bar member comprises a T-bar, and the vertically upstanding, longitudinally extending body comprises a body of the “T” of the T-bar.

25. The apparatus of claim 21, wherein the longitudinally spaced and mutually connected force sensors are connected to a sensor control board including an analog amplifier and a microprocessor in communication with a Bluetooth transceiver including a Bluetooth antenna.

26. The apparatus of claim 25, further comprising a battery pack of rechargeable cells operably coupled to power the two or more longitudinally spaced and mutually connected force sensors and the sensor control board.

27. The apparatus of claim 25, further comprising a remote Bluetooth to Ethernet Bridge Controller including a base Bluetooth transceiver including a Bluetooth antenna, a microprocessor, an Ethernet port for communication to a client server via a wired connection, or a WiFi transceiver for communication to a client server via a wireless connection.

28. A storage cell for a pallet bearing a load of articles; the storage cell comprising:
a floor of a facility;
a rectangular, visible boundary for the storage cell on the floor; and
a longitudinally extending pressure bar including two or more force sensors located along and proximate to a single side of the storage cell.

29. The storage cell of claim 28, wherein:
the longitudinally extending pressure bar is located along and proximate a side of the storage cell opposite a side identified for entry of a pallet into the storage cell; and
the longitudinally extending pressure bar includes two or more back stops facing the side identified for entry, the two or more back stops positioned to permit a side substantially parallel to the longitudinally extending pressure bar of a pallet entering the storage cell to move over the two or more force sensors before contacting the back stops.

30. The storage cell of claim 28, wherein:
the longitudinally extending pressure bar is located along and proximate a side of the storage cell adjacent a side identified for entry of a pallet into a storage cell; and
the longitudinally extending pressure bar includes a single back stop proximate an end thereof and facing an opposite end of the longitudinally extending pressure bar along a length thereof, the single back stop positioned to permit a side of a pallet entering the storage cell and moving substantially parallel to the longitudinally extending pressure bar to move over the two or more force sensors before contacting the single back stop.

31. The storage cell of claim 28, further including a sensor control board operatively coupled to the two or more force sensors and including an analog amplifier, a microprocessor, a Bluetooth transceiver with antenna, and a power supply comprising rechargeable battery cells for providing power to components of the longitudinally extending pressure bar.

32. A method of monitoring depletion of articles from a pallet located in a storage cell, the method comprising:
moving the pallet into the storage cell until a side of the pallet contacts at least one back stop of a pressure bar including two or more force sensors along and adjacent one side of the storage cell;
lowering the pallet to a floor of the storage cell and over the two or more force sensors of the pressure bar; and
outputting signals from the two or more force sensors indicative of removal of articles from the pallet from a Bluetooth transceiver to a base Bluetooth transceiver.

33. The method of claim 32, further comprising moving the pallet into the storage cell over and parallel to the pressure bar to contact a single back stop at an end of the pressure bar and lowering the pallet after the contact.

34. The method of claim 32, further comprising moving the pallet into the storage cell from a side of the storage cell opposite a location of the pressure bar and perpendicular to the pressure bar to contact two or more back stops in a position over the two or more force sensors, and lowering the pallet after the contact.
